(19) United States
(12) Patent Application Publication
(10) Pub. No.: US 2011/0234897 A1
(43) Pub. Date: Sep. 29, 2011

(54) DISPLAY APPARATUS AND DISPLAY METHOD

(75) Inventor: Masakuni Yamamoto, Yamato-shi (JP)

(73) Assignee: CANON KABUSHIKI KAISHA, Tokyo (JP)

(21) Appl. No.: 13/132,960

(22) PCT Filed: Jan. 21, 2010
(86) PCT No.: PCT/JP2010/051074

§ 371 Date: Jun. 6, 2011

(30) Foreign Application Priority Data
Feb. 5, 2009 (JP) 2009-024850

(51) Int. Cl. H04N 11/20; H04N 7/01; G09G 5/00

(52) U.S. Cl. 348/445; 348/E11.021; 348/E07.003

(57) ABSTRACT

A display apparatus includes a display for block interlace scanning such that scanning lines in the display screen are classified into M blocks, and the interlace scanning is conducted one block by one block, to display on the M blocks the video data in the speed of M times in the same display timing as a speed of a single times.

### TECHNICAL FIELD

The present invention relates to a display apparatus and a display method, and particularly relates to a display apparatus which displays images at a speed of M times and a display method therefor.

### BACKGROUND ART

A Braun tube (CRT: Cathode Ray Tube), which makes electrons collide with fluorophores on a screen with the use of an electron gun and makes the fluorophores emit light due to energy generated by the collision, is superior in display quality and cost performance and has been used for a display apparatus in televisions, personal computers and the like for a long period of time. In recent years, the research and development for flat panel displays (FPD: Flat Panel Display) which regards space saving, convenience and portability as important in place of a heavy and bulky CRT is progressing, and the technology is being commercialized.

FPDs include a non-emissive type liquid crystal display, a light-emitting type plasma display (PD), a field emission display (FED), and an organic electroluminescence (Electro Luminescence) display. FPDs are increasingly further required to have larger screens with higher definition or smaller screens with higher definition.

Along with the tendency of the higher definition, a PD and an FED which employ passive matrix driving cause problems that the display time of each pixel becomes short or an image is not displayed during a time period between the present display and the next display, and accordingly that a flicker becomes prominent when a dark moving image is displayed, in particular. There is a method of solving the problems by displaying an image at a multiple of normal speed, and thereby increasing a display frequency per unit time. There is another method of carrying out a scanning-line-interlacing display (block interlace), and thereby increasing a field frequency.

On the other hand, an organic EL display and a liquid crystal display which employ active matrix driving have a problem of causing a blurred moving image because each pixel continues lighting for one scanning period. The solution method includes a method of displaying an image at a multiple of normal speed, and displays black between the scanning periods to sharpen a moving image.

Each driving system can form an image of higher definition by driving at a multiple of normal speed. At this time, it is important that a video image is displayed at the same timing as a timing at which the imaging apparatus takes the video data therein. However, this point is not conventionally taken into consideration.

In addition, even when an image is formed in higher definition by using the scanning-line-interlacing display (block interlace), it is not taken into consideration to display the image at the same timing as a timing at which the imaging apparatus takes a video data therein.

The problems of driving at a multiple of normal speed will now be described with reference to FIG. 18 to FIG. 20. FIG. 18 is a view for describing a display at a speed of a single times (constant speed). The display at the speed of the single times (speed of equal time) described here means that a video data is displayed at the same timing as a timing at which an imaging apparatus has taken the video data therein. Here, an example will be described in which an original video data taken at a rate of 60 frames per second is displayed at the rate of 60 frames per second. In the figure, a display screen 79 is shown, and eight horizontal lines represent scanning lines (horizontal pixel rows (lines)) at a horizontal position in the display screen. Suppose that as the line moves to the right, the time advances.

A period 80 represents a time period in which a frame is displayed once, in other words, represents the length of 1/60 seconds. A hold type display apparatus such as an organic EL display accesses a pixel of each scanning line at the time at a starting point 81 shown by each arrow, and writes a video data corresponding to the pixel in the retention capacity of the pixel with a voltage programming method or an electric current programming method. The written value is held until the time reaches the end point of the arrow denoted by 82 (until new data is written), an electric current according to the data written into the light-emitting device flows in the period, and the device continues lighting.

On the other hand, an impulse type display apparatus such as the FED accesses a pixel of each scanning line within the time at the starting point 81 shown by each arrow, and applies a voltage value or an electric current value according to the video data to a light-emitting device, and the device emits light according to the value. Hereafter, a hold type display apparatus will be described, but a similar content can be applied to an impulse type display apparatus as well.

By the way, a scanning method for a conventional general display apparatus is referred to as a line sequential method. This is a method of accessing a scanning line downward one by one from the top of the display screen and making each pixel display the value according to the video data.

For instance, when the number of pixels in the display screen is the VGA (row×line=640×480), the number of the scanning lines is 480. When one frame is displayed, a time period in which the apparatus can access one scanning line is approximately 34.7 microseconds (=( 1/60)/480). Simultaneously, a period displayed after the access operation has moved to the adjacent scanning line is also 34.7 microseconds.

When one frame of the video data is displayed, a time period spends approximately 1/60 seconds after the top scanning line is displayed and until the bottom scanning line is displayed. In other words, there is a lag time of approximately 1/60 seconds between the display of the top scanning line and the display of the bottom scanning line. A rhombic region 83 shown by the lower right diagonal lines represents a time period in which each scanning line displays the video data in the same frame.

The shape of the rhombus is equivalent to the times of lags appearing on each scanning line, which occur when the imaging apparatus such as a CCD camera takes the video data therein. In other words, in the case in which a video data is displayed at the speed of a single times (constant speed) as illustrated in FIG. 18, the video data is displayed in the same timing as a timing at which the video data has been taken into the imaging apparatus, and is displayed in a more natural way.

Next, a conventional display at double speed will be described with reference to FIG. 19. Here, an example will be described in which an original video data taken at 60 frames per second is displayed in sub frames every twice within 1/60 seconds. A period 84 in the figure represents a time period in which a sub frame is displayed once, in other words, represents the length of 1/120 seconds. In the case of this speed, there is a lag time of approximately 1/120 seconds between the start of the display of the top scanning line and the end of the display of the bottom scanning line, when the video data in the same frame is displayed. A rhombic region 85 shown by the lower right diagonal lines represents a time period in which each scanning line displays the video data in the same frame.

In the case of a display at double speed, the apparatus can access each pixel twice in the period and can insert a black display between accesses as a countermeasure for blurring or take a countermeasure for flicker, but the display timings are different as is understood when FIG. 19 is compared to FIG. 18. When the display apparatus having a fast response speed such as an organic EL display and an FED displays a moving image in a way illustrated in FIG. 19, the moving image results in being awkwardly displayed.

In the case of the display at double speed, a time period in which the apparatus can access one scanning line when displaying one frame is approximately 17.3 microseconds (=( 1/120)/480), and simultaneously a time period in which the access operation moves to the adjacent scanning line is also 17.3 microseconds.

FIG. 20 is a view for describing a display at triple speed. Here, an example will be described in which an original video data taken at 60 frames per second is displayed in sub frames every three times within 1/60 seconds. A period 86 represents a time period in which a sub frame is displayed once, in other words, represents the length of 1/180 seconds. In the case of this speed, there is a lag time of 1/180 seconds between the start of the display of the top scanning line and the end of the display of the bottom scanning line, when the video data in the same frame is displayed. A rhombic region 87 shown by the lower right diagonal lines represents a time period in which each scanning line displays the video data in the same frame.

In the case of display at triple speed, the apparatus can access each pixel three times in the period and can insert a black display between accesses as a countermeasure for blurring or take a countermeasure for flicker, but the display timings are different as the speed multiplier increases, as is understood when FIG. 20 is compared to FIG. 18. As the display apparatus having a fast response speed such as an organic EL display and an FED increases the speed multiplier, the moving image results in being awkwardly displayed.

In the case of a display at triple speed, a time period in which the apparatus can access one scanning line when displaying one frame is approximately 11.5 microseconds (=( 1/180)/480), and simultaneously, a time period in which the access operation moves to the adjacent scanning line is also 11.5 microseconds.

Next, a problem in a scanning-line-interlacing display (block interlace) will be described which is used as a countermeasure for flicker. The scanning-line-interlacing display is, in other words, a method of dividing a display screen into a plurality of blocks, displaying an image line-sequentially in the block, and accessing a scanning line one by one from top to bottom in the screen in every block. This method causes a divisional stripe noise pattern in a boundary between the blocks.

Next, the divisional stripe noise pattern will be described with reference to FIG. 21A to FIG. 21C. As is illustrated in FIG. 21A, for instance, suppose that the straight object moves from a position “a” to a position “b” on the screen during the display time for one frame. As is illustrated in FIG. 21B, also suppose that the apparatus carries out a scanning-line-interlacing display (block interlace driving) with respect to a moving image with a display which has been divided into two upper and lower blocks by a central dividing line across the screen.

FIG. 21B illustrates a state where a video data of a frame I+1 is overwritten on the video data of a frame I in each of the upper and lower screens. Each of the broken lines on the upper and lower screens is a portion on which a data is overwritten. On the line, the video data is discontinued by the length by which the object has moved, but this portion is sequentially overwritten, so the video data seems to be continuous to human eyes when the screen is scanned at a high speed.

However, when the video data in a new frame starts to be written, a chasm in the object is formed between the upper screen and the lower screen at the dividing line across the screen, by the length by which the object has moved. This portion does not change during scanning. Accordingly, when a new video data is sequentially overwritten, the object seems to move discontinuously, to human eyes. This is a degradation phenomenon referred to as a divisional stripe noise pattern. This divisional stripe noise pattern cannot be solved by driving the scanning at a multiple of normal speed and even by scanning the screen at any higher speed in a display method like above.

There is a system disclosed in Japanese Patent Application Laid-Open No. H10-268261 (Patent Document 1), for instance, as a method of solving the divisional stripe noise pattern. In Patent Document 1, a field is used in description, but a frame is used here instead.

Specifically, the method in Patent Document 1 makes the upper screen display the video data so as to constantly delay by one frame behind a frame in the lower screen, as is illustrated in FIG. 21C. In the upper screen, a video data of a frame I+2 is overwritten on the displayed video data of a frame I+1. On the other hand, in the lower screen, a video data of the frame I+1 is overwritten on the displayed video data of the frame I.

At the scanned portion on the broken line, the object is discontinued by the length corresponding to one frame by which the object has moved, similarly to the case of FIG. 21B, but this portion is sequentially overwritten, so the video data seems to be continuous to human eyes when the screen is scanned at a high speed. In addition, a chasm of the object is not formed at the position at which the screen is divided, because the same video data of the frame I+1 is displayed on each of the upper and lower screens at the position. Therefore, the problem that the image is discontinued due to the divisional stripe noise pattern can be solved.

There is a method of displaying at a multiple of normal speed such as double and triple speeds so as to obtain an image of a higher definition, as was described above, but the method still has a problem that a moving image is awkwardly displayed in a display apparatus having a fast response speed such as an organic EL display and an FED.

There is also a method of carrying out a scanning-line-interlacing display (block interlace) as another method for displaying an image with higher definition. This method has a problem of the divisional stripe noise pattern, as described above. The method for solving the problem according to Patent Document 1 can display the video data without discontinuing the object, when viewed through human eyes.

However, the method according to Patent Document 1 simultaneously displays data in three frames as is illustrated in FIGS. 21A to 21C, and accordingly has a problem that a moving image is distorted. Patent Document 1 describes an example in which a screen is divided into two, but when the number of the divided screens further increases, the number of continuous frames to be simultaneously displayed also increases, which causes a problem of distorting the moving image.

FIG. 8 in Patent Document 1 illustrates a method of scanning the screen upward and downward from the center of the screen, and FIG. 9 illustrates a method of scanning the screen towards the center of the screen from the top and the bottom of the screen, which is an effective method for preventing the divisional stripe noise pattern. However, the method cannot display a natural image, because the display timing differs from a correctly displaying timing.

An object of the present invention is to provide a display apparatus which can display a natural image even when displaying an image at a fast response speed, and can inhibit the image from deteriorating due to a divisional stripe noise pattern.

### DISCLOSURE OF THE INVENTION

According to a first aspect of the present invention, a display apparatus for displaying a video data of N frames/sec in a speed of M times in a display screen comprising a plurality of pixels arranged in a matrix comprises: a conversion unit for converting the video data of N frames/sec into a video data in the speed of M times, wherein N and M are natural numbers; and a display unit for block interlace scanning such that scanning lines in the display screen are classified into M blocks, and the interlace scanning is conducted one block by one block, to display on the M blocks the video data in the speed of M times in the same display timing as a speed of a single times.

According to a second aspect of the present invention, a display apparatus for displaying a video data of N frames/sec in a speed of M times in a display screen comprising a plurality of pixels arranged in a matrix comprises: a conversion unit for converting the video data of N frames/sec into a video data in the speed of M times, wherein N and M are natural numbers; and a display unit for block interlace scanning such that scanning lines in the display screen are classified into L blocks, wherein L is natural numbers larger than M, and the interlace scanning is conducted one block by one block, to display on the L blocks the video data in the speed of M times in the same display timing as a speed of a single times.

According to a third aspect of the present invention, a display method for displaying a video data of N frames/sec in a speed of M times in a display screen comprising a plurality of pixels arranged in a matrix comprises steps of: converting the video data of N frames/sec into a video data in the speed of M times, wherein N and M are natural numbers; and block interlace scanning such that scanning lines in the display screen are classified into M blocks, and the interlace scanning is conducted one block by one block, to display on the M blocks the video data in the speed of M times in the same display timing as a speed of a single times.

According to a fourth aspect of the present invention, a display method for displaying a video data of N frames/sec in a speed of M times in a display screen comprising a plurality of pixels arranged in a matrix comprises steps of: converting the video data of N frames/sec into a video data in the speed of M times, wherein N and M are natural numbers; and block interlace scanning such that scanning lines in the display screen are classified into L blocks, wherein L is natural numbers larger than M, and the interlace scanning is conducted one block by one block, to display on the L blocks the video data in the speed of M times in the same display timing as a speed of a single times.

### Advantages of the Invention

The display apparatus and the display method according to the present invention can display a video data in the same timing as a timing at which an imaging apparatus takes a video data in or in a timing close to the timing, even when a display apparatus such as an organic EL display and an FED having a fast response speed is driven at a multiple of normal speed. Therefore, the display apparatus can display the natural video image. Furthermore, the apparatus can inhibit a flicker or the deterioration of the moving image display characteristics.

In addition, the apparatus and the method according to the present invention show an effect of preventing the divisional stripe noise pattern even when a block interlace driving method is employed. Furthermore, the apparatus can approach the display even in the case where the speed multiplier is smaller than the block number, to a display in the speed of a single times (constant speed), and can inhibit the divisional stripe noise pattern, the flicker and the deterioration of the moving image characteristics while displaying a natural video image.

Further features of the present invention will become apparent from the following description of exemplary embodiments with reference to the attached drawings.

### BRIEF DESCRIPTION OF THE DRAWINGS

FIG. 1 is a block diagram illustrating one embodiment of a display apparatus according to the present invention.

FIG. 2 is a view for describing a block interlace driving method to be used in the present invention.

FIG. 3 is a timing chart for describing a double speed two-block interlace driving method according to the present invention.

FIGS. 4A, 4B, 4C and 4D are views for describing a display timing of a scanning line in a double speed two-block interlace driving method according to the present invention, in detail.

FIG. 5 is a view illustrating a timing for displaying a video data of one frame in a double speed two-block interlace driving method according to the present invention.

FIG. 6 is a timing chart for describing a triple speed three-block interlace driving method according to the present invention.

FIG. 7 is a view illustrating timing for displaying a video data of one frame in the triple speed three-block interlace driving method according to the present invention.

FIG. 8 is a view illustrating a state of a buffer memory and a display screen at the time T1 in the triple speed three-block interlace driving method according to the present invention.

FIG. 9 is a view illustrating a state of a buffer memory and a display screen at the time T2 in the triple speed three-block interlace driving method according to the present invention.

FIG. 10 is a view illustrating a state of a buffer memory and a display screen at the time T3 in the triple speed three-block interlace driving method according to the present invention.

FIG. 11 is a view for describing one example of a light-emitting device of a display apparatus according to the present invention.

FIG. 12 is a view for describing one example of a pixel array in a display apparatus according to the present invention.

FIGS. 13A, 13B and 13C are views for describing an example of a product to which the display apparatus according to the present invention is applied.

FIG. 14 is a view illustrating a block configuration of a display screen according to another embodiment of the present invention.

FIG. 15 is a view for describing a display data when a block interlace driving method is employed in the block configuration of the display screen in which the speed multiplier is smaller than the block number according to another embodiment of the present invention.

FIG. 16 is a view illustrating a timing of displaying a video data for one frame according to another embodiment of the present invention.

FIG. 17 is a view illustrating a timing of displaying a video data for one frame according to another embodiment of the present invention.

FIG. 18 is a view for describing a display at a speed of a single times.

FIG. 19 is a view for describing a display at double speed.

FIG. 20 is a view for describing a display at triple speed.

FIGS. 21A, 21B and 21C are views for describing a divisional stripe noise pattern and a conventional method for solving the noise pattern.

### DESCRIPTION OF THE EMBODIMENTS

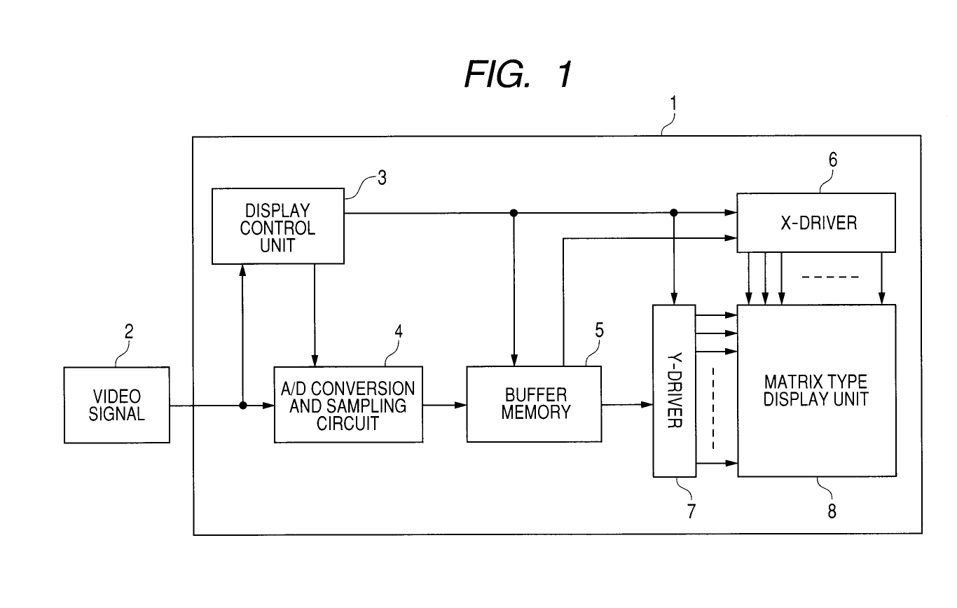

An embodiment for carrying out an invention will now be described below in detail with reference to the drawings. FIG. 1 is a block diagram illustrating one embodiment of a display apparatus according to the present invention. A display apparatus 1 has at least a display control unit 3, and an A/D conversion and sampling circuit 4 having a function of an A/D conversion circuit and a sampling circuit. The display apparatus 1 has further a buffer memory 5, an X-driver 6, a Y-driver 7 and a matrix type display unit 8.

The matrix type display unit 8 includes a plurality of pixels which are arranged in a matrix form. Each pixel includes a light-emitting device, and a pixel circuit for driving the light-emitting device and the like when the display unit is an active matrix type. An FED, an organic EL display and the like are used for the matrix type display unit 8. In the following description, the organic EL display shall be used for the matrix type display unit.

The display control unit 3 is a control circuit for controlling each unit in the apparatus, and controls a unit so as to convert an image signal 2 input from the outside into a video data for every pixel. The display control unit 3 also reads out the converted video data for every pixel, which is stored in the buffer memory 5, according to the specified scanning line in the matrix type display unit 8. The display control unit 3 further controls the X-driver 6 and the Y-driver 7 to write data according to the video data into the scanning line. (In the case of an FED or the like, the control unit applies a voltage or an electric current to the scanning line.) Here, the image signal of N frames/second is displayed at a speed of M times.

The image signal 2 of the N frames/second may be an analog signal such as a video signal or a digital signal as in a DVD. When the image signal 2 is input into the display apparatus 1, the video data for each pixel is stored in the buffer memory 5 by the A/D conversion and sampling circuit 4 according to the directions from the display control unit 3. Suppose that the buffer memory 5 has a capacity, for instance, for two frames (which will be described in detail below). The buffer memory 5 shall overwrite a new video data on an old video data, in each frame.

On the other hand, the video data of each pixel, which is stored in the buffer memory 5, is read out according to the control of the display control unit 3, and is displayed on the matrix type display unit 8 while being scanned by the X-driver 6 and the Y-driver 7 at a speed of M times. When the video data is displayed at the speed of M times, the video data results in being read out at an M times faster speed than a speed at which the video data is written into the buffer memory 5. The image is displayed with a block interlace driving method so as to be displayed at the timing close to a speed of a single times (constant speed), which will be described below.

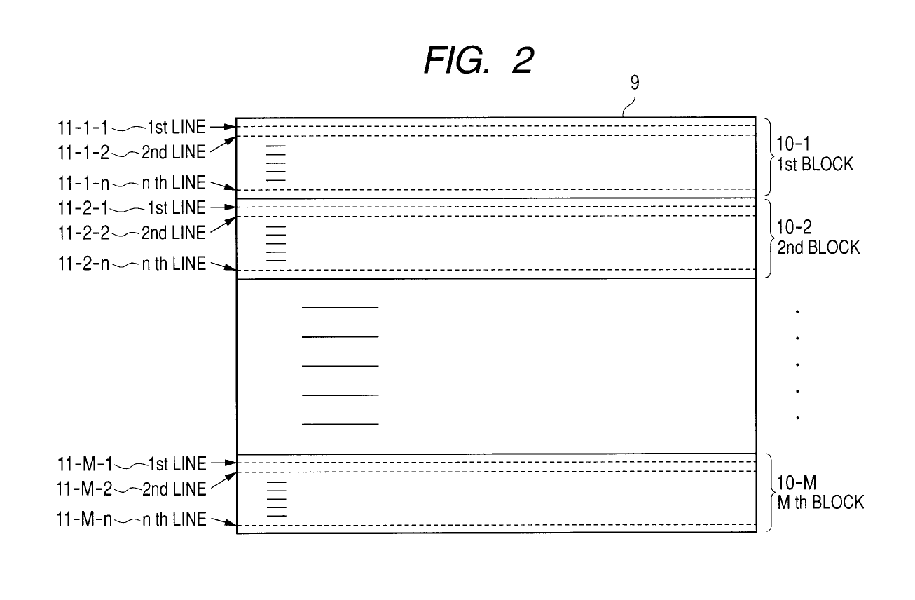

Next, a procedure of displaying an image with a block interlace driving method which is used in the display apparatus according to the present invention will be described with reference to FIG. 2. In the figure, a display screen 9 is shown. The display screen 9 is a display screen of the matrix type display unit 8 of FIG. 1. When an image is displayed at a speed of M times, the display screen 9 is divided into M blocks from the first block to the Mth block as is illustrated in 10-1 to 10-M. Here, M of the speed of M times is defined by the number of times that the display control unit accesses the pixel in a time period in which one frame is displayed. In the speed of a single times, the access number is one time, in double speed, the access number is twice, in triple speed, the access number is three times, and thus in the speed of M times, the access number is M times.

For instance, in the case of double speed, the display screen is divided into two blocks, and in the case of triple speed, the display screen is divided into three blocks. The display screen 9 is not actually divided into M blocks. In addition, the display control unit does not make the Y-driver 7 access a scanning line in a sequential order from the top to the bottom such as in a conventional order, but makes the Y-driver 7 scan the lines while selecting every one line in every block and skipping every other lines.

Each block shall have approximately the same number of scanning lines therein. The first line to the nth line in the first block 10-1 is denoted by 11-1-1 to 11-1-n, respectively. The first line to the nth line in the second block 10-2 is denoted by 11-2-1 to 11-2-n, respectively. The first line to the nth line in the Mth block 10-M is denoted by 11-M-1 to 11-M-n, respectively.

Suppose that the screen is a VGA with a size (row×line=640×480), for instance, the number of the scanning lines is 480. That is to say, in the case of double speed, the display screen is divided into two blocks (M=2), and the number of the scanning lines in each block is 240 lines (n=240). In the case of triple speed, the display screen is divided into three blocks (M=3), and the number of the scanning lines in each block is 160 lines (n=160).

When a video data in a new frame starts to be displayed, the first line 11-1-1 in the first block 10-1 is selected by the Y-driver 7, and the video data is written into each pixel by the X-driver 6. (In the case of an FED or the like, the display control unit applies a voltage or an electric current to each pixel.) Subsequently, the first line 11-2-1 in the second block 10-2 is selected by the Y-driver 7, and the video data is written into each pixel by the X-driver 6. (In the case of the FED or the like, the display control unit applies a voltage or an electric current to each pixel.)

When the display of the video data of the first line in each block has been finished finally in the Mth block 10-M, the display returns back to the first block 10-1 again, the second line 11-1-2 is selected by the Y-driver 7, and the video data is written into each pixel by the X-driver 6. (In the case of the FED or the like, the display control unit applies a voltage or an electric current to each pixel.)

This operation is iterated. Then, one scanning line is selected in every block, and the video data is written into each pixel. When only one block is viewed, lines are displayed sequentially from the first line to the bottom line, in any block. Now, suppose that the display speed at the speed of a single times (constant speed) is 60 frames per second, then the access time for one scanning line is 34.7 microseconds (=( 1/60)/480), and simultaneously the time necessary for the access to move to the adjacent scanning line is 34.7 microseconds as well.

On the other hand, in the display at the speed of M times, the time of accessing one scanning line is (34.7/M) microseconds. At this time, when each block is viewed, an access period after some scanning line has been accessed and before a next scanning line in the same block is accessed (from the first line 11-1-1 to the second line 11-1-2 in the first block 10-1, for instance) is 34.7 microseconds (=(34.7/M)×M). This access period is the same as in the speed of a single times (constant speed).

In other words, when the image is displayed at the speed of M times, the image can be displayed at a timing close to the speed of the single times (constant speed) by dividing the display screen 9 into M blocks as was described above and interlace-scanning the blocks.

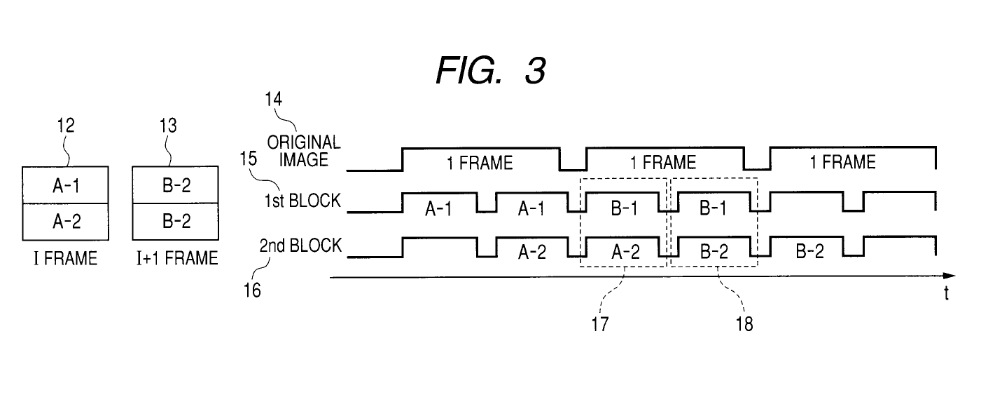

Next, a procedure in the case of the display at double speed will be described below as a more specific example with reference to FIG. 3 to FIG. 5. A procedure for displaying the video data in the continuous two frames in a double speed two-block interlace driving method will now be described below with reference to FIG. 3. When the video data of 60 frames per second is displayed at double speed, the image results in being displayed by two sub-frames.

In the figure, the video data 12 in a frame I is shown. The video data in the first block is represented by A-1, and the video data in the second block is represented by A-2. The video data 13 in a frame I+1 is a video data next to the frame I. The video data in the first block is represented by B-1, and the video data in the second block is represented by B-2.

Timing charts 14, 15 and 16 illustrate display timings, and an original image 14 shows a temporal timing at which an original video data of 60 frames per second is sent. The video data corresponding to one frame is sent in every 1/60 seconds. This is sequentially and temporarily stored by the buffer memory having the capacity of two frames, which will be described later. The video data 15 is a video data which is displayed in the first block, and the video data 16 is a video data which is displayed in the second block.

Here, focus attention on continuous two sub-frames 17 and 18. In the sub-frame 17, the video data in the first block 15 displays B-1, and the video data in the second block 16 displays A-2. In the following sub-frame 18, the video data in the first block 15 displays B-1, and the video data in the second block 16 displays B-2. Hereafter, the displays in the two sub-frames are iterated.

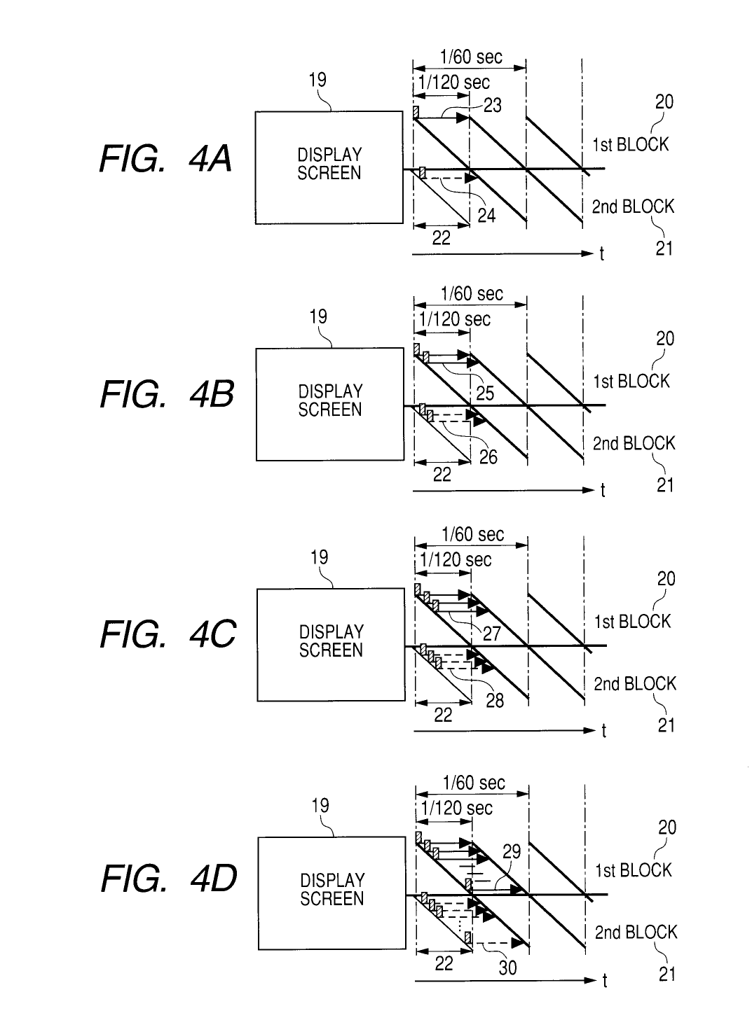

This operation will be described in detail with reference to FIG. 4A to FIG. 4D. FIGS. 4A to 4D illustrate a timing at which an image is displayed on a scanning line with a double speed two-block interlace driving method. In the figure, a display screen 19 is shown. The upper screen is the first block 20 and the lower screen is the second block 21. In a period 22, which is 1/120 seconds, one sub-frame is displayed at double speed. Several oblique lines extending toward lower right directions are auxiliary lines which show timings of sequentially displaying an adjacent scanning line when the image is displayed at a speed of a single times (constant speed).

When the sub-frame 17 illustrated in FIG. 3 starts to be displayed, the first line 23 in the first block 20 is selected as is illustrated in FIG. 4A, and the video data corresponding to the first line of the video data B-1 in a frame I+1 is written into pixels and displayed. Subsequently, the first line 24 of the second block 21 is selected, and the video data corresponding to the first line of the video data A-2 in a frame I is written into the pixels and displayed. A time period in which the first line 23 of the first block 20 is selected is approximately 17.3 microseconds (=34.7/2).

After that, the second lines 25 and 26 in respective blocks are sequentially selected as is illustrated in FIG. 4B. Then, the video data corresponding to the second line of the video data B-1 in the frame I+1 and the video data corresponding to the second line of the video data A-2 in the frame I are written into the pixels and displayed.

In this block interlace driving method, an access period after a certain scanning line in each block has been accessed and before the next scanning line in the same block is accessed is approximately 34.7 microseconds, and is equivalent to that in the case of a speed of a single times (constant speed). In other words, the start positions of the first line and the second line are aligned on auxiliary straight lines which obliquely extend toward the lower right direction in the figure.

Subsequently, third lines 27 and 28 in respective blocks are sequentially selected as is illustrated in FIG. 4C. Then, the video data corresponding to the third line of the video data B-1 in the frame I+1 and the video data corresponding to the third line of the video data A-2 in the frame I are written into the pixels and displayed. Similarly, the start positions of the third lines are aligned on the auxiliary straight lines which obliquely extend toward the lower right direction. The similar operation is sequentially iterated hereafter, and lines up to the final lines in respective blocks are displayed as are illustrated in FIG. 4D.

Specifically, the final lines 29 and 30 in the first and second blocks are sequentially selected as are illustrated in FIG. 4D. Then, the video data corresponding to the last line of the video data B-1 in the frame I+1 and the video data corresponding to the last line of the video data A-2 in the frame I are written into the pixels and displayed. As is understood from the figures, the auxiliary straight line at the start time when the second block 21 is displayed is positioned temporally one line prior to (in left side of) an auxiliary straight line which shows the start time when the first block 20 is displayed.

Next, the sub-frame 18 illustrated in FIG. 3 shall be displayed. As for the video data, a video data B-1 is written into the first block and is displayed, and a video data B-2 is written into the second block and is displayed.

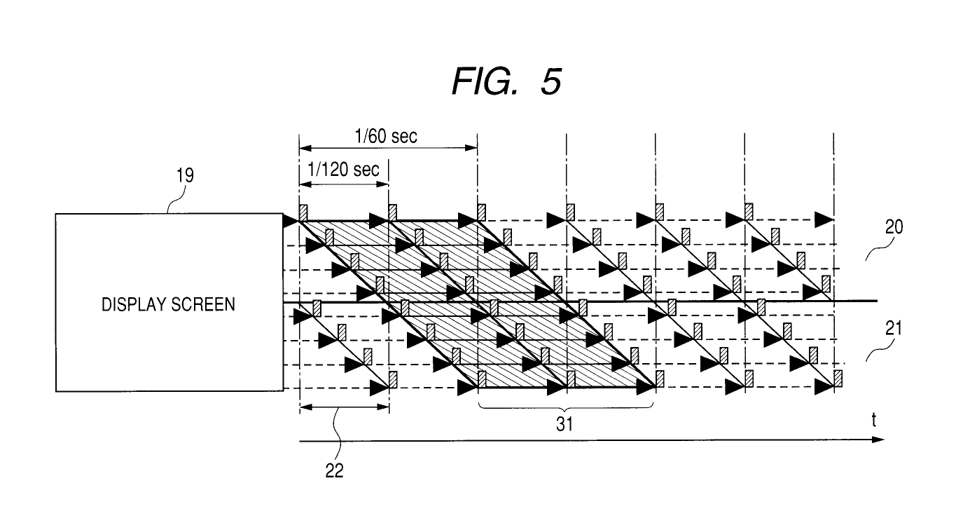

FIG. 5 collectively illustrates the display by the double speed two-block interlace driving method. In FIG. 5, the same portions as in FIGS. 4A to 4D are denoted by the same reference numerals. Here, an example will be described in which an original video data taken at a rate of 60 frames per second is displayed at double speed. In FIG. 5, eight lines on a side of a display screen 19 represent scanning lines (horizontal pixel rows (lines)), which are similarly shown in positions on a side of the display screen. Suppose that as the line moves to the right, the time shall advance.

In the figure, the first block 20 and the second block 21 are shown, and a period 22 represents a time period in which a sub-frame is displayed once, in other words, the length of 1/120 seconds. A display procedure shall follow the description in FIG. 4A to FIG. 4D. A rhombic region 31 shown by the lower right diagonal lines represents a time period in which each scanning line displays the video data in the same one frame.

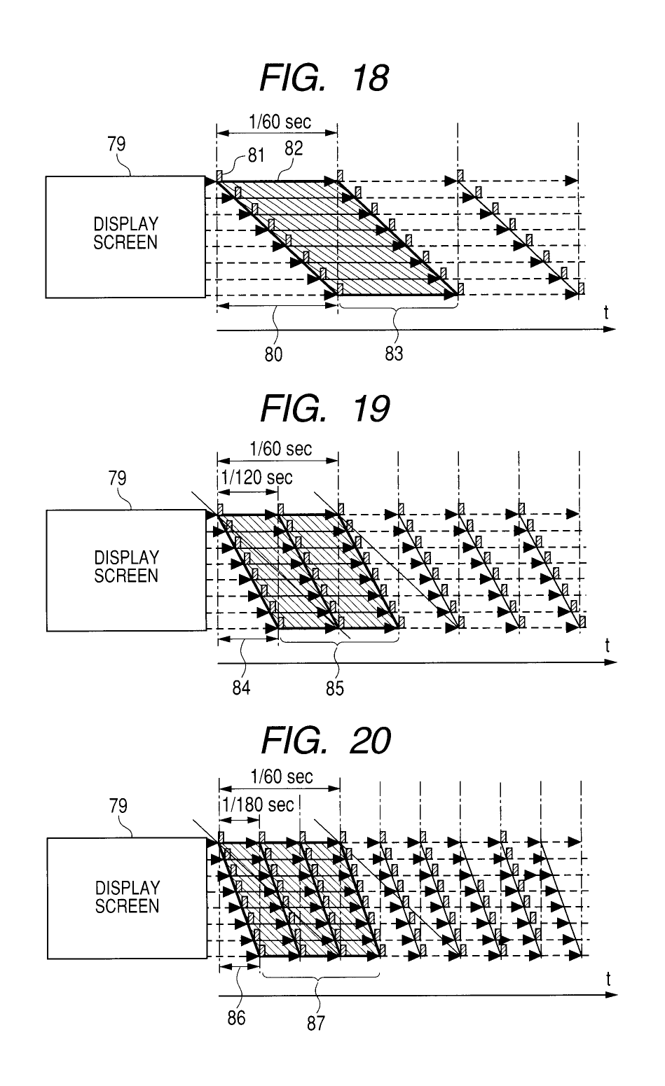

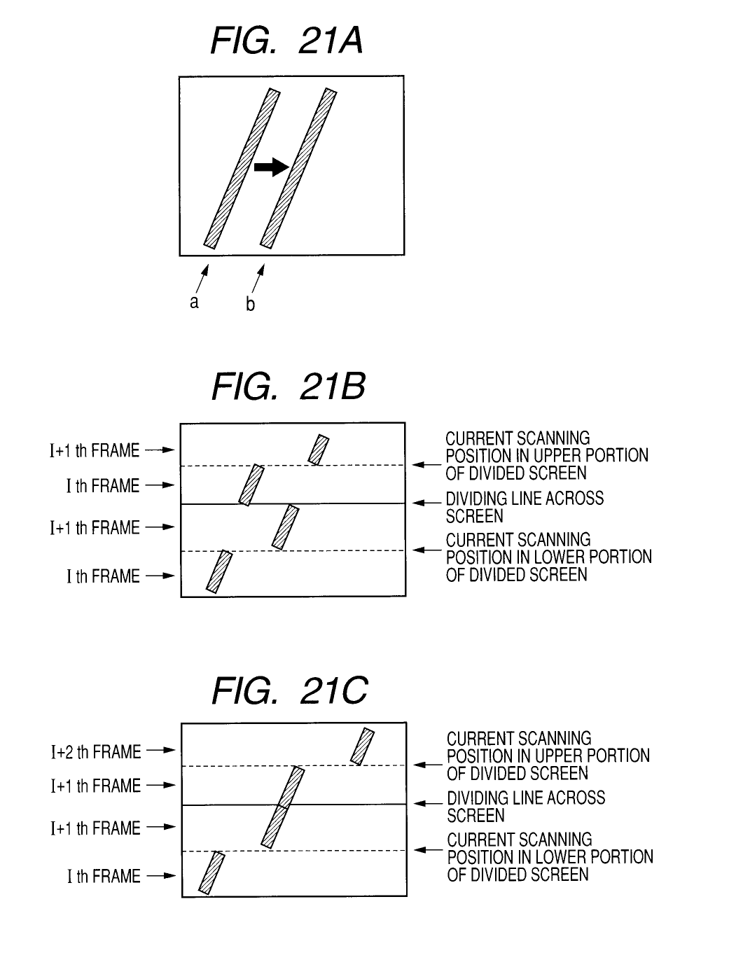

As is understood from FIG. 5, each of the scanning lines is selected twice and the display timing is equivalent to that in the case of a speed of a single times (constant speed) illustrated in FIG. 18. Specifically, in spite of being displayed at double speed, the image is not displayed at the same timing as the timing of the double speed illustrated in FIG. 19, but is displayed at the timing equivalent to the timing of the speed of a single times (constant speed) illustrated in FIG. 18. As a result, a more natural image is displayed. In this method, the image is not deteriorated by the divisional stripe noise pattern as illustrated in FIG. 21A to FIG. 21C; and furthermore, the moving image is not distorted.

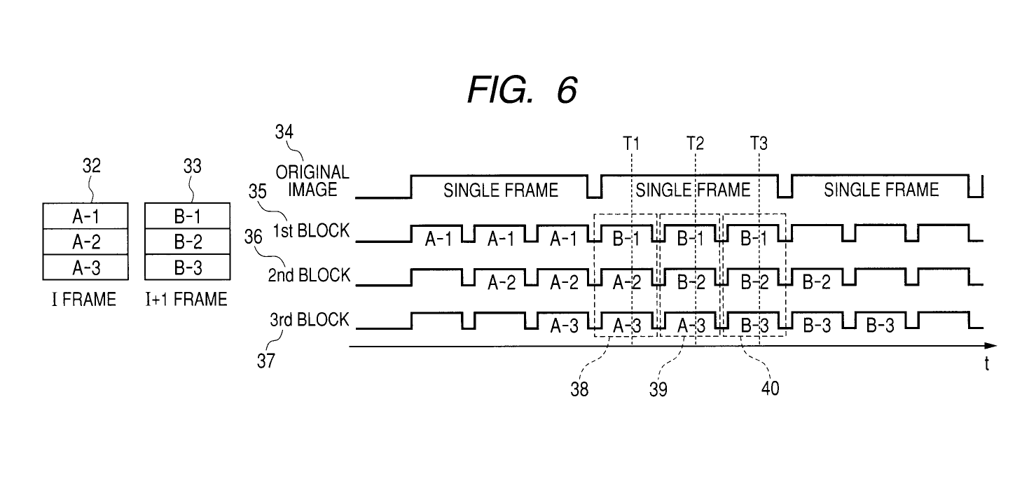

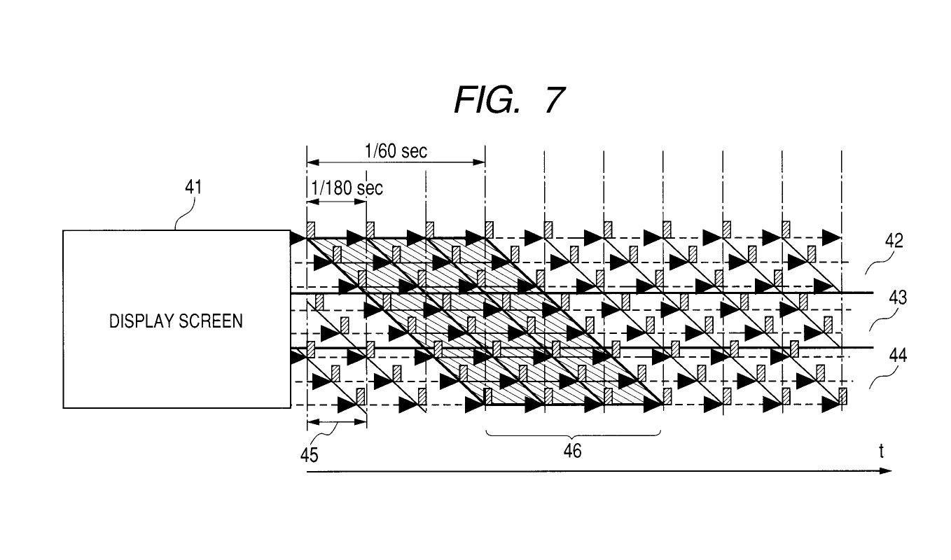

Next, a procedure in the case where an image is displayed at triple speed will be described as more specific another example with reference to FIG. 6 and FIG. 7. FIG. 6 is a timing chart for describing a triple speed three-block interlace driving method. A procedure for displaying a video data in continuous three frames in a triple speed three-block interlace driving method will now be described below with reference to FIG. 6. When the video data of 60 frames per second is displayed at triple speed, the image results in being displayed by three sub-frames.

In the figure, the video data 32 in a frame I is shown. The video data in the first block is represented by A-1, the video data in the second block is represented by A-2, and the video data in the third block is represented by A-3. Similarly, the video data 33 in a frame I+1 is a video data next to the frame I. The video data in the first block is represented by B-1, the video data in the second block is represented by B-2, and the video data in the third block is represented by B-3.

Timing charts 34, 35, 36 and 37 illustrate display timings, and an original image 34 shows a temporal timing at which an original video data of 60 frames per second is sent. The video data corresponding to one frame is sent in every 1/60 seconds. These video data are sequentially and temporarily stored by the buffer memory having the capacity of two frames, which will be described later. The video data 35 is a data which is displayed in the first block, the video data 36 is a data which is displayed in the second block, and the video data 37 is a data which is displayed in the third block.

Here, focus attention on continuous three sub-frames 38, 39 and 40. In the sub-frame 38, the video data in the first block 35 displays B-1, the video data in the second block 36 displays A-2, and the video data in the third block 37 displays A-3. In the subsequent sub-frame 39, the video data in the first block 35 displays B-1, the video data in the second block 36 displays B-2, and the video data in the third block 37 displays A-3. In the subsequent sub-frame 40, the video data in the first block 35 displays B-1, the video data in the second block 36 displays B-2, and the video data in the third block 37 displays B-3.

A procedure of displaying an image with the three blocks interlace driving method can be easily guessed from the descriptions on FIG. 4A to FIG. 4D, so a detailed description will be omitted here. In this triple speed three-block interlace driving method as well, an access period after some scanning line in each block has been accessed and before the next scanning line in the same block is accessed is approximately 34.7 microseconds, and is equivalent to that in the case of a speed of a single times (constant speed). That is to say, the start positions of respective scanning lines are aligned on the auxiliary straight lines which show the timings equivalent to those in the case of the speed of the single times.

FIG. 7 collectively illustrates the display by a triple speed three-block interlace driving method in a similar way to FIG. 5. Here, an example will be described in which an original video data taken at a rate of 60 frames per second is displayed at triple speed.

In FIG. 7, eight lines on a side of a display screen 41 represent scanning lines (horizontal straight pixel rows (lines)), which are similarly shown in positions on the side of the display screen. As the line moves to the right, the time advances. The first block 42, the second block 43 and the third block 44 are shown. A period 45 represents a time period in which a sub-frame is displayed once, in other words, represents the length of 1/180 seconds.

In the figure, a rhombic region 46 shown by the lower right diagonal lines represents a time period in which each scanning line displays the video data in the same one frame. As is understood from FIG. 7, each of the scanning lines is selected three times and the display timing is equivalent to that in the case of a speed of a single times (constant speed) illustrated in FIG. 18.

Specifically, in spite of being displayed at triple speed, the image is not displayed at the same timing as the timing of the triple speed as illustrated in FIG. 20, but is displayed in the timing equivalent to the timing of a speed of a single times (constant speed) illustrated in FIG. 18. As a result, a more natural image is displayed. In addition, the image is not deteriorated by the divisional stripe noise pattern illustrated in FIG. 21, and the moving image also is not distorted.

In the above, examples of the double speed two-block interlace driving method and the triple speed three-block interlace driving method were described. Here, a display method by an M times speed M blocks interlace driving method according to the present invention will now be described below.

First, a frame I is divided into M blocks, and the video data in each block are represented by (A-1), (A-2), (A-3), . . . , (A-M) in this order from the top to the bottom of the display screen. In addition, a frame I+1 next to the frame I is also divided into M blocks, and the video data in each block is represented by (B-1), (B-2), (B-3), . . . , (B-M) in this order from top to bottom in the display screen.

In the case of the M times speed M blocks interlace driving method, the image is displayed by the sub frames of M times. When X is defined by values from 1 to M (X=1 to M), the video data to be displayed by the scanning of an Xth frame is displayed so as to be (B-1), (B-2), (B-3), . . . , (B-X), (A-(X+1)), (A-(X+2)), (A-(X+3)), . . . , (A-M) in this order from top to bottom in the display screen.

For instance, in the case of M=4,

when X=1, the video date is displayed in the order of (B-1), (A-2), (A-3) and (A-4).

When X=2, the video date is displayed in the order of (B-1), (B-2), (A-3) and (A-4).

When X=3, the video date is displayed in the order of (B-1), (B-2), (B-3) and (A-4).

When X=4, the video date is displayed in the order of (B-1), (B-2), (B-3) and (B-4).

In the case of M=5,

when X=1, the video date is displayed in the order of (B-1), (A-2), (A-3), (A-4) and (A-5).

When X=2, the video date is displayed in the order of (B-1), (B-2), (A-3), (A-4) and (A-5).

When X=3, the video date is displayed in the order of (B-1), (B-2), (B-3), (A-4) and (A-5).

When X=4, the video date is displayed in the order of (B-1), (B-2), (B-3), (B-4) and (A-5).

When X=5, the video date is displayed in the order of (B-1), (B-2), (B-3), (B-4) and (B-5).

Generally, in the case of M (>5),

when X=1, the video date is displayed in the order of (B-1), (A-2), (A-3), (A-4), (A-5), . . . , (A-M).

When X=2, the video date is displayed in the order of (B-1), (B-2), (A-3), (A-4), (A-5), . . . , (A-M).

When X=3, the video date is displayed in the order of (B-1), (B-2), (B-3), (A-4), (A-5), . . . , (A-M).

When X=4, the video date is displayed in the order of (B-1), (B-2), (B-3), (B-4), (A-5), . . . , (A-M).

Thus, the blocks are continued, and when X=X, the video date is displayed in the order of (B-1), (B-2), . . . , (B-X), (A-(X+1)), . . . , (A-M).

Thus, the blocks are continued, and when X=M, the video date is displayed in the order of (B-1), (B-2), (B-3), (B-4), . . . , (B-M).

As is understood from the above description, the timing of switching a display between the video data of the frame I and the video data of the subsequent frame I+1 is in the position of each 1/M of the total number of the scanning lines in M sub-frames at the display of the speed of the M times, sequentially from top to bottom in the display screen of the display apparatus.

Therefore, the display apparatus according to the present invention results in displaying a video data in the same frame in the timing equivalent to the timing of a speed of a single times (constant speed) illustrated in FIG. 18, even when the image is displayed with a block interlace scanning method with a speed of any times, and accordingly can display a natural image. In addition, the moving image is not deteriorated by the divisional stripe noise pattern, and also is not distorted.

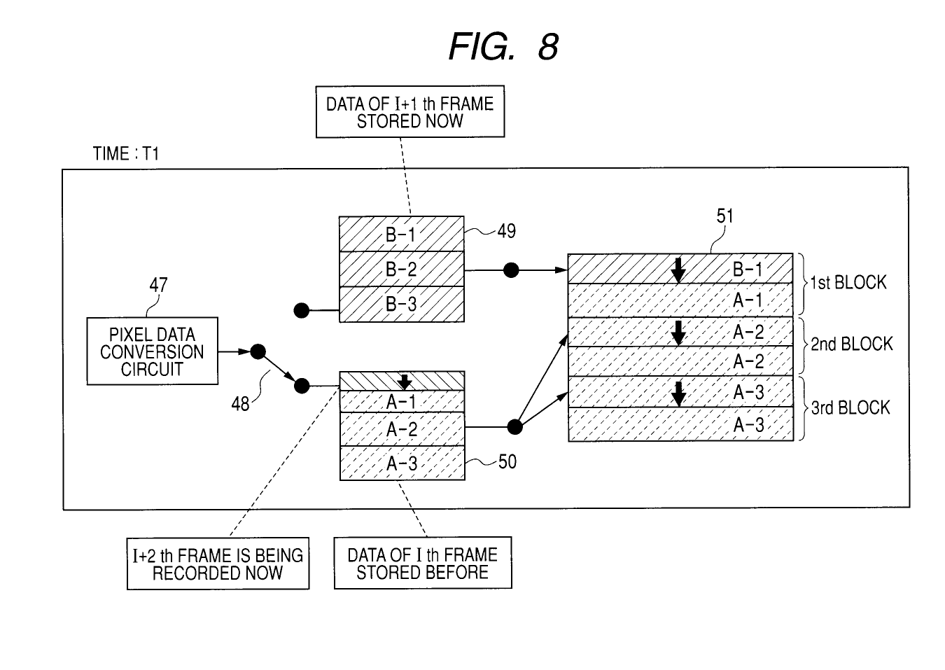

Next, a method for converting an original video data of 60 frames per second into a video data for a triple times three blocks interlace driving method using two frame memories as a buffer memory will be described below with reference to FIG. 8 to FIG. 10. FIG. 8 to FIG. 10 respectively illustrate the flows of the video data at certain times T1, T2 and T3 within display periods 38, 39 and 40 for three continuous sub-frames illustrated in FIG. 6.

In addition, the first frame memory 49 and the second frame memory 50 illustrated in FIG. 8 to FIG. 10 correspond to a buffer memory 5 having the capacity for two frames of FIG. 1, and a display screen 51 corresponds to the display screen of the matrix type display unit 8 of FIG. 1. A pixel data converting portion 47 shall correspond to the A/D conversion and sampling circuit 4 of FIG. 1, and a switch 48 and the like shall be included in the buffer memory 5. In FIG. 8 to FIG. 10, other X-driver 6, Y-driver 7 and the like are omitted.

First, as is illustrated in FIG. 8 to FIG. 10, an image signal is converted into a digital data for each pixel by the pixel data conversion circuit 47 having a function of the A/D conversion and sampling circuit. The converted digital video data is switched for every frame by a switch 48, and is alternately stored in the first frame memory 49 and the second frame memory 50. Specifically, the video data taken at a rate of 60 frames per second is stored in the first and second frame memories 49 and 50, while being sequentially switched for every frame.

Now, as is illustrated in FIG. 8, suppose that the video data (B-1, B-2 and B-3) in the frame I+1 has been already stored in the first frame memory 49. Also suppose that the video data (A-1, A-2 and A-3) in the frame I has been already stored in the second frame memory 50, and that the video data in the (I+2)th frame is being newly overwritten thereon. The speed of writing the video data is 60 frames per second, the speed of reading the video data is 180 frames per second because of being triple speed.

A display screen 51 is shown, and the image is displayed with a three blocks interlace driving method. The scanning line is selected by a not-shown Y-driver 7 according to the three blocks interlace driving method. The video data corresponding to the selected line is read out from the first frame memory 49 or the second frame memory 50, is written into a pixel on the scanning line selected through a not-shown X-driver 6, and is displayed.

At the time T1 of FIG. 8, the data of a new frame I+2 is overwritten on the video data of A-1 existing in the first block of the second frame memory 50. In the meantime, B-1 of the video data in the first block is read out from the first frame memory 49, is sequentially written into the first block of the display screen 51 through the X-driver 6, and is displayed.

In addition, A-2 and A-3 of the video data respectively in the second and third blocks are read out from the second frame memory 50, are sequentially written into the second and third blocks of the display screen 51 through the X-driver 6, and are displayed.

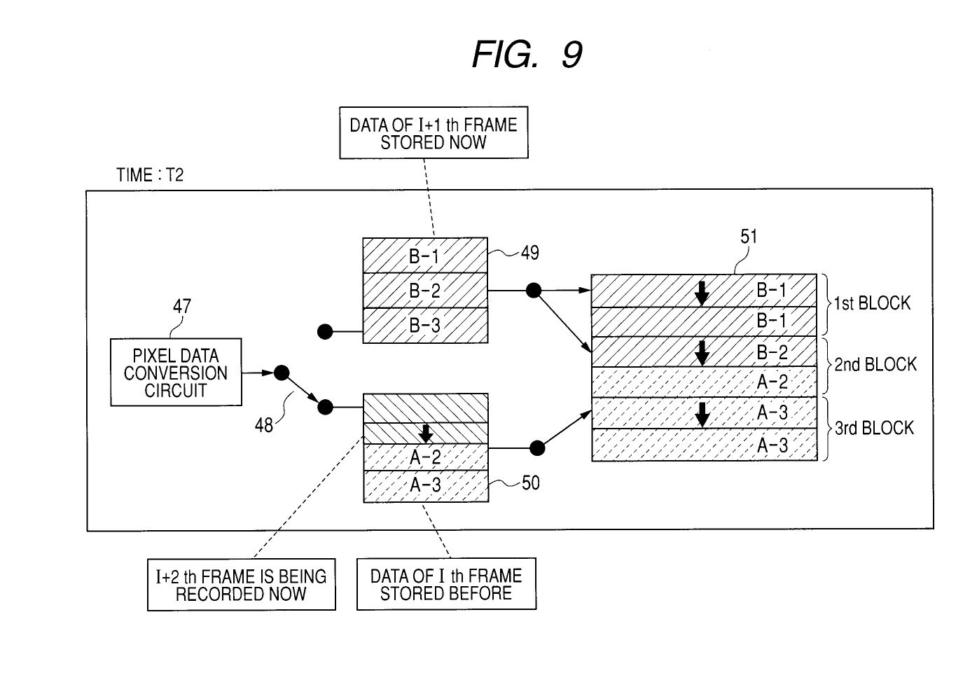

At the time T2 of FIG. 9, the data of the new frame I+2 is overwritten on the video data of A-2 in the second block of the second frame memory 50. In the meantime, B-1 and B-2 of the video data respectively in the first and second blocks are read out from the first frame memory 49, are sequentially written into the first and second blocks of the display screen 51 through the X-driver 6, and are displayed. In addition, A-3 of the video data in the third block is read out from the second frame memory 50, is sequentially written into the third block of the display screen 51 through the X-driver 6, and is displayed.

At the time T3 of FIG. 10, the data of the new frame I+2 is overwritten on the video data of A-3 in the third block of the second frame memory 50. In the meantime, B-1, B-2 and B-3 of the video data respectively in the first, second and third blocks are read out from the first frame memory 49, are sequentially written into the first, second and third blocks of the display screen 51 through the X-driver 6, and are displayed.

As long as there is a frame memory in which the original video data of two frames can be temporally stored, the original video data of N frames/second can be displayed at a speed of M times with an M blocks interlace driving method. In addition, the original video data can be similarly displayed also with an other times speed interlace driving method such as a double speed two-block interlace driving method.

In the above, the M times speed M blocks interlace driving method was described in which the video data of N frames/second is displayed by every M times. At this time, the display apparatus according to the present invention may display a video data by every M times in total, so as to prevent blurring which occurs when the moving image is displayed, by using a video data in which the brightness of the original video data has been relatively changed or a video data which has been image-processed from the previous and/or following frames.

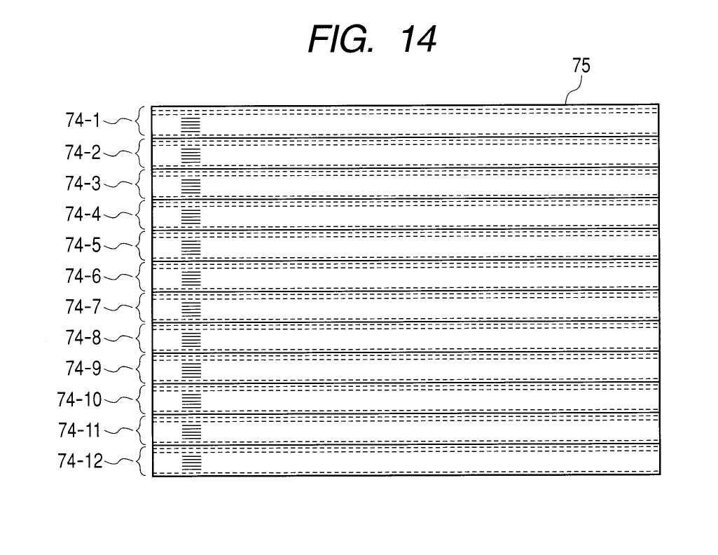

Next, another embodiment according to the present invention will be described below with reference to FIG. 14 to FIG. 17. The display apparatus in the present embodiment displays an image which is closer to the display at a speed of a single times (constant speed), even when the speed multiplier is smaller than the block number. The structure of the display apparatus according to the present embodiment is the same as that of the first embodiment, and the display method is the same as that described in the first embodiment except that the image is displayed with an M times speed L blocks interlace driving method (L>M).

In FIG. 14, blocks 74-1 to 74-12 and a display screen 75 are shown. Here, the display screen is divided into 12 blocks. The scanning lines are selected and scanned in the order of skipping every other lines in every block in a similar way to the description for FIG. 2. In this case, the image is displayed not at a speed of twelve times but at a speed of six times (accessing pixel six times in period of one frame), which is the half of the speed of twelve times.

Here, the video data of the Ith frame is divided into 12 blocks to form (A-1), (A-2), (A-3), . . . , (A-12) from the top, and the video data of the subsequent (I+1)th frame is divided into 12 blocks to form (B-1), (B-2), (B-3)), . . . , ((B-12) from the top. In other words, the video data of the frame I is divided into L blocks which are represented by (A-1), (A-2), (A-3)), . . . , ((A-L) in this order from top to bottom. In addition, the video data of the subsequent frame I+1 is divided into L blocks which are represented by (B-1), (B-2), (B-3)), . . . , ((B-L) in this order from top to bottom.

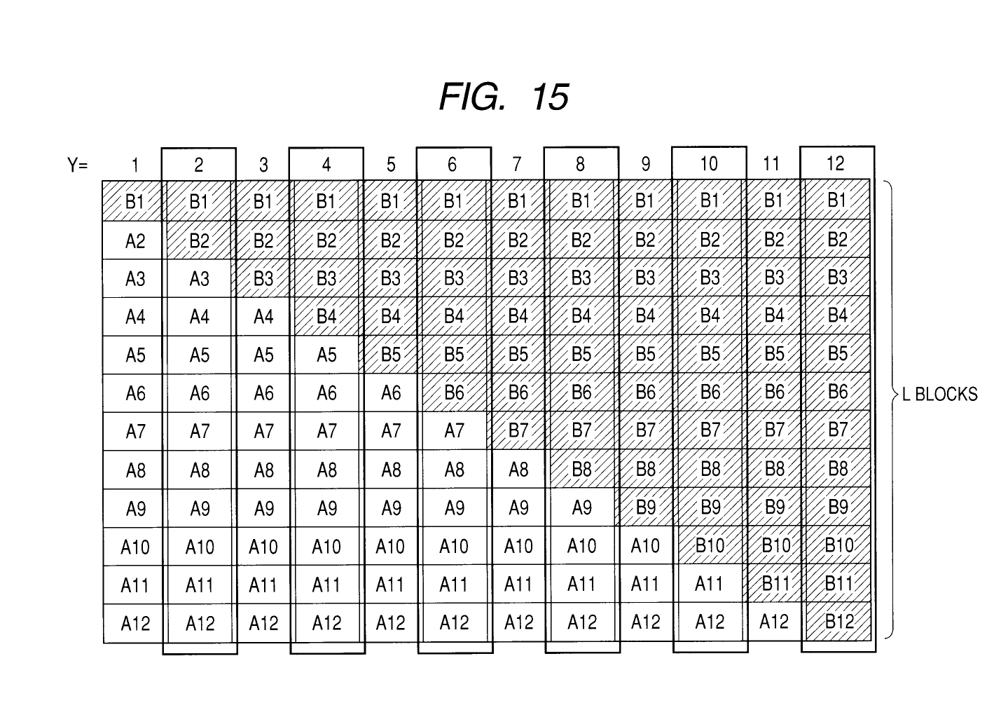

FIG. 15 illustrates the order of the video data to be displayed from Y=first to Y=twelfth, when an image is displayed with a twelve times speed twelve blocks interlace driving method. As is understood from FIG. 15, a timing of switching a display between the video data of the frame I and the video data of the subsequent frame I+1 exists in the position of each 1/12 of the total number of the scanning lines in 12 sub frames sequentially from top to bottom in the screen. (The boundary between a region shown by the diagonal line and a region shown by the white line in FIG. 15)

When the video data of one frame is divided into L (=12) blocks and is displayed at the speed of L (=12) times, the sub frames of Y=1 to 12 may be sequentially displayed while the display is switched from the frame I (A) to the frame I+1 (B) according to the display method in the first embodiment. In contrast to this, in the present embodiment, when the image is displayed at only a speed of M (=6) times, the M (=6) sub frames are selected from the sub frames of Y=1 to 12 and are displayed.

In other words, 6 sub frames among the combination are used to display at the speed of six times, here. For instance, the image is displayed with a six times speed twelve blocks interlace driving method in the order of Y=2, 4, 6, 8, 10 and 12 as illustrated in FIG. 15. Specifically, when Y is a natural number larger than M and varies from 1 to L, from L display combinations of blocks (B-1), (B-2), (B-3)), . . . , ((B-Y) and (A-(Y+1)), . . . (A-L), M combinations of the blocks are selected to be displayed as M sub frames, in an order from the sub frame of smallest Y value to the sub frame of largest Y value in the display screen.

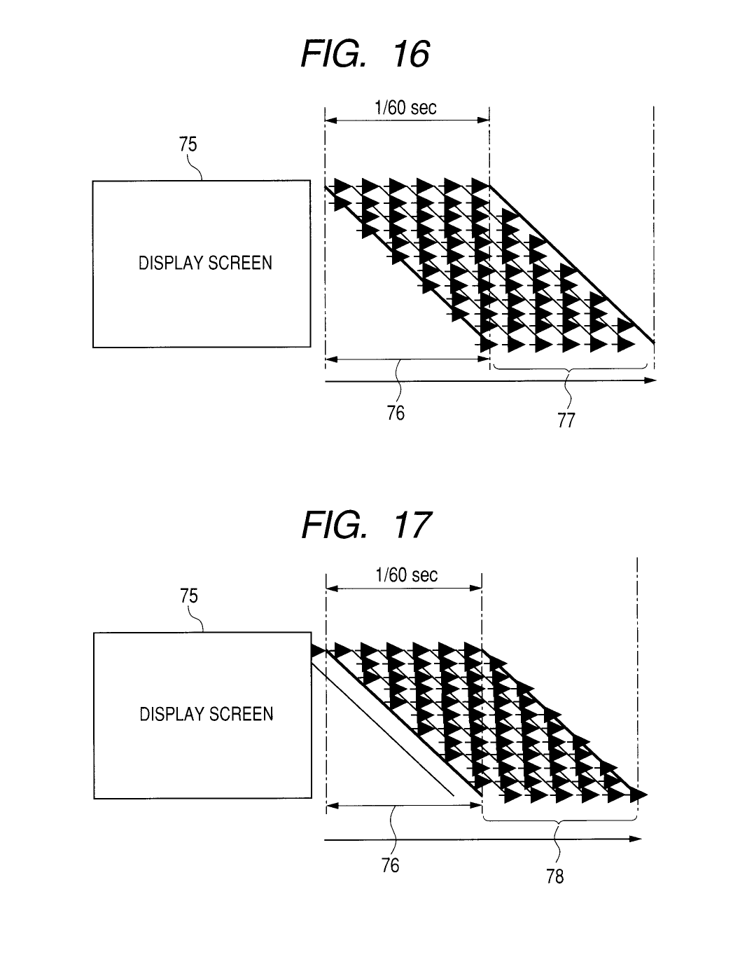

FIG. 16 illustrates a representative line of timings, which shows each head of the scanning lines in 12 blocks when the video data in one frame according to the present embodiment is displayed. In the figure, a period 76 represents 1/60 seconds. The divisional stripe noise pattern does not occur on the boundary between the second block and the third block, on the boundary between the fourth block and the fifth block, on the boundary between the sixth block and the seventh block, and on the boundary between the eighth block and the ninth block. Furthermore, the divisional stripe noise pattern does not occur on the boundary between the tenth block and the eleventh block. In addition, it is understood that the display timings 77 are close to those in the case of the speed of the single times (constant speed) illustrated in FIG. 18.

Similarly, when the image is displayed with a six times speed twelve blocks interlace driving method in a display order of Y=1, 3, 5, 7, 9 and 11, the display timings become those shown by 78 of FIG. 17. In this case, the divisional stripe noise pattern does not occur on the boundary between the first block and the second block, on the boundary between the third block and the fourth block, on the boundary between the fifth block and the sixth block, and on the boundary between the seventh block and the eighth block. Furthermore, the divisional stripe noise pattern does not occur on the boundary between the ninth block and the tenth block and on the boundary between the eleventh block and the twelfth block. In addition, it is understood that the display timings are close to those in the case of the speed of the single times (constant speed) illustrated in FIG. 18.

As was described above, the display apparatus can display an image which is closer to the display at the speed of the single times (constant speed) by using an L blocks interlace driving method (L>M and L=12 in the above described example) at the speed of M times (M=6 in the above described example), even when the speed multiplier is smaller than the block number. In addition, the divisional stripe noise pattern occurring on each boundary can be alleviated by alternately carrying out the display illustrated in FIG. 16 and the display illustrated in FIG. 17 as were described above.

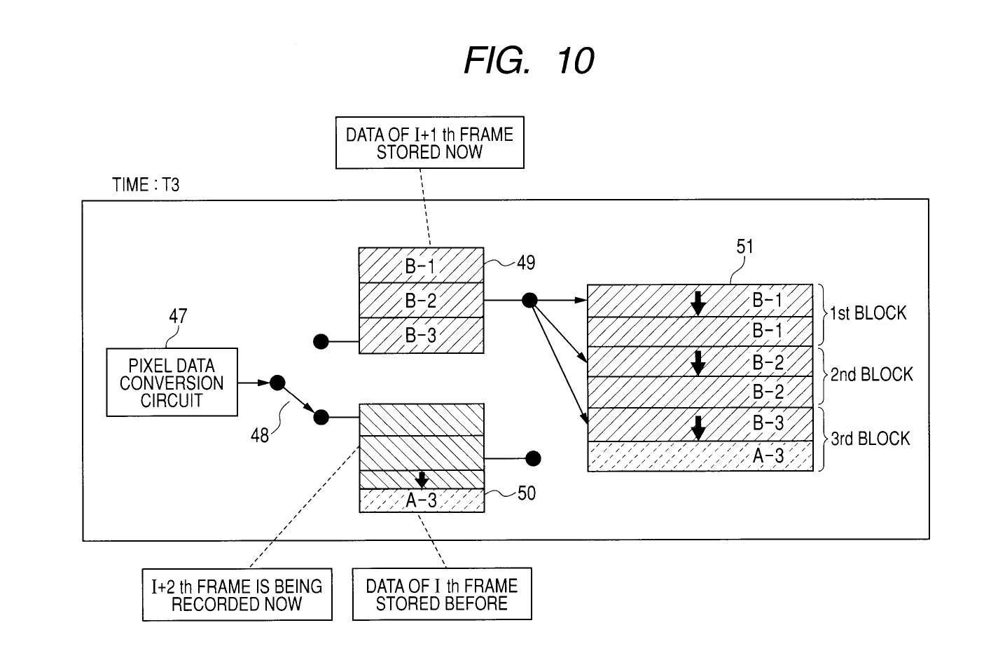

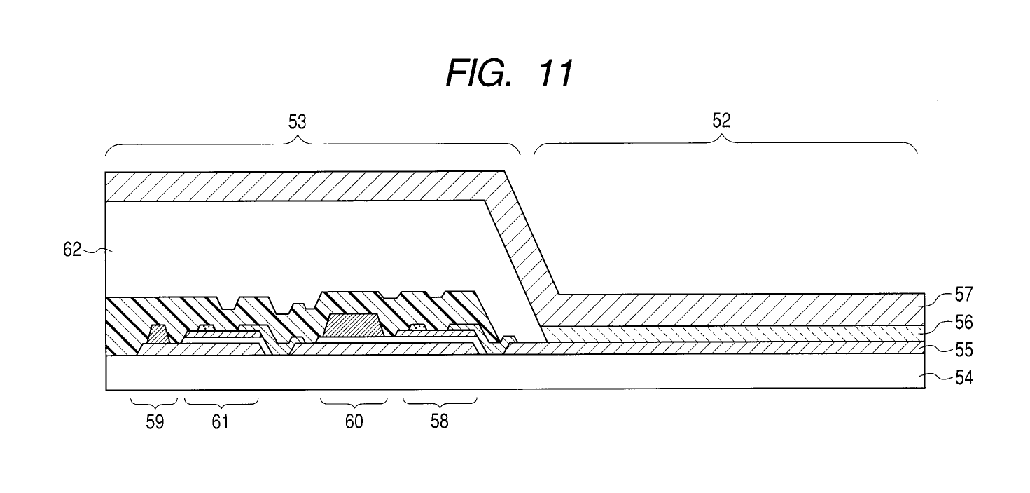

FIG. 11 is a schematic sectional view illustrating a device section of an organic EL display, and a circuit and wiring for driving the device, as one example of the display apparatus according to the present invention. In FIG. 11, a region 52 is formed of the organic EL device and a region 53 is formed of the circuit section for driving the organic EL device 52 and the like. The regions are formed on a substrate 54 such as a glass plate.

The display apparatus which is described here has a structure in which the organic EL device 52 and the circuit section 53 are horizontally arranged, but may have a structure in which the components are vertically arranged. In addition, a method for producing the organic EL device 52, which is described here, is a method of applying an organic light-emitting layer 57 on a region sandwiched by banks 62, with a nozzle method, an ink jet method or the like, but other methods such as a vapor-deposition method and a photothermal transfer method may be used.

The organic EL device 52 has at least a pair of electrodes formed of an anode 55 and a cathode 57, and an organic light-emitting layer 56 formed of one layer or a multilayer, which is sandwiched between the pair of the electrodes. The anode 55 is a conductor having transparency such as ITO, for instance, and is produced with a sputtering method or the like. The cathode 57 is made from a metal such as Al, for instance, and is produced with a vapor-deposition method or the like. The organic light-emitting layer 56 includes at least a light-emitting layer relating to light emission, and emits light due to a reaction that a positive hole injected from an anode 55 side recombines with an electron injected from a cathode 57 side in the light-emitting layer.

The organic EL device shown here is so-called a bottom emission type in which the emitted light directs toward a substrate 54 side, but may be a top emission type in which light is emitted toward the opposite side of the substrate 54, of course. In the case, the anode and the cathode shall be reversely arranged, or alternatively the opposite electrode shall have the transparency.

The organic light-emitting layer 56 formed of only one light-emitting layer can also emit the light, but may have a structure in which a hole injection layer, a hole transporting layer, an electron transporting layer and an electron injection layer are stacked so as to sandwich the light-emitting layer, in order to increase the injectability of the positive hole and the electron. The light-emitting layer may also include a barrier layer for balancing the densities of the positive hole and the electron, or preventing the device from being deteriorated by the movement of the materials in each layer to the other layers. Furthermore, the light-emitting layer 56 may be made from such a fluorescent material as to emit a fluorescent light, or may be made from a material including a fluorescent material of a host doped with a phosphorescent material of a guest, which emits a phosphorescent light.

The circuit section 53 includes a driver transistor (Dr-Tr) portion 58 for supplying an electric current to the organic EL device 52, a retention capacity portion 60 for writing the value of the video data therein which have been sent through a data line 59, and a switch transistor (Sw-Tr) 61. The switch transistor (Sw-Tr) 61 switches between decisions of permitting the writing of information with the use of a not-shown selection line or not permitting the writing.

FIG. 12 is a schematic block diagram illustrating a pixel circuit of an organic EL display, as one example of a display apparatus according to the present invention. As is illustrated in FIG. 12, the active-matrix type display apparatus has a plurality of data lines 63-1, 63-2 and so on, which intersect with a plurality of selection lines 64-1, 64-2 and so on. Pixels 65-1 to 65-4 and so on are arranged on respective intersections. The respective pixels 65-1 to 65-4 and so on include pixel circuits 66-1 to 66-4 and so on, and organic EL devices 67-1 to 67-4 and so on.

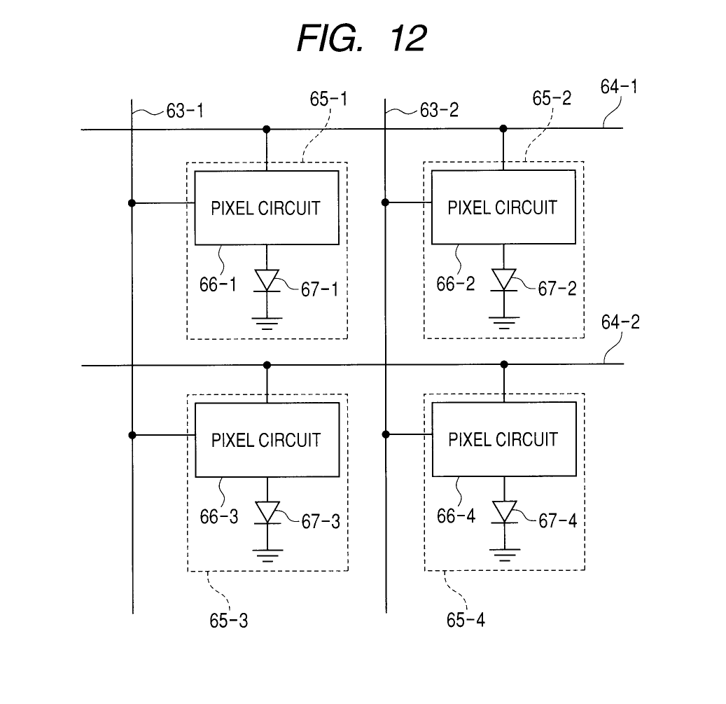

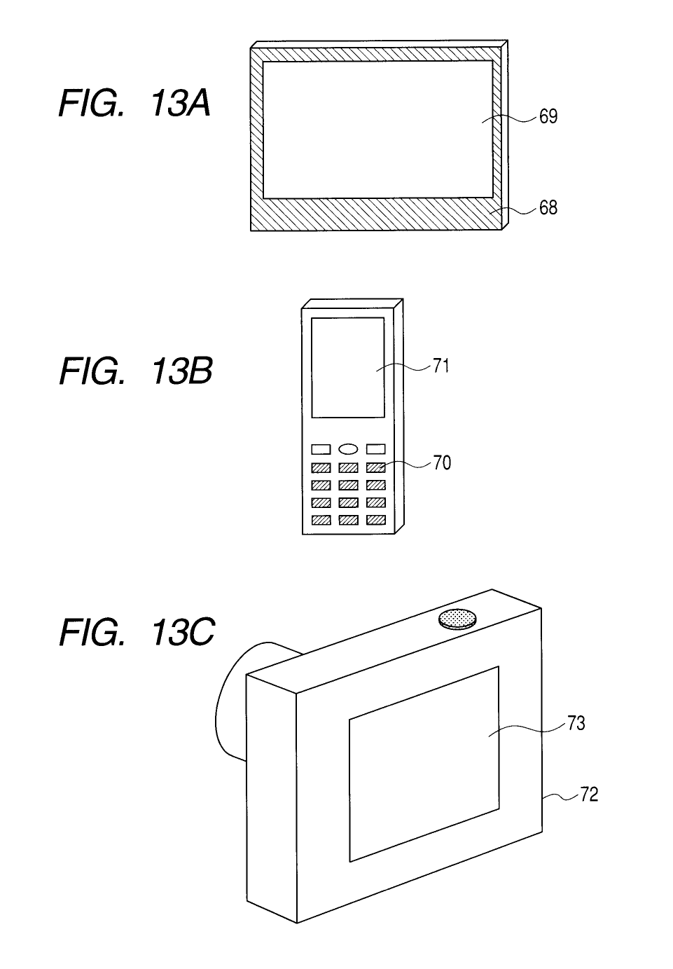

FIG. 13A to FIG. 13C are views illustrating an application example of the display apparatus according to the present invention. FIG. 13A illustrates an example of a video display apparatus such as a television set, which uses the display apparatus according to the present invention. A housing 68 of the video display apparatus is shown. The housing 68 has a receiving circuit for television broadcasting, a voice outputting portion, a controlling portion for controlling the video display apparatus and the like built-in, in addition to the display apparatus illustrated in FIG. 1, and can display the video image of the television broadcasting and the like on a display region 69 according to the order of the user.

When the video display apparatus employs the above described organic EL device as a pixel, the apparatus displays an image with a large contrast which is a ratio of a white display to a black display, because the organic EL device itself emits light, and accordingly can display an image of high quality. The display apparatus can be also used as a monitor of a control apparatus of a computer or the like, other than the video image display.

FIG. 13B illustrates an example in which the display apparatus according to the present invention is used in a portable telephone 70 as a portable device. FIG. 13C illustrates an example in which the display apparatus according to the present invention is similarly used in a digital still camera 72 as a portable device. The display apparatus according to the present invention can be applied not only to these portable apparatuses, but also to an inputting apparatus of a still image or a moving image, a portable information inputting and outputting apparatus, and further a portable game apparatus as well.

In FIG. 13B, a housing of a portable telephone 70 is shown. The housing 70 has a number inputting portion, a small video-image-inputting portion, a transmission and reception portion of a voice and a video image, a control portion for controlling a portable apparatus and the like built-in, in addition to the display apparatus illustrated in FIG. 1. Then, the display apparatus can display a content which has been input from the inputting portion according to the order of the user, a video image which has been taken in through the video image inputting portion, or a received video image, on a display region 71.

In FIG. 13C, a housing of a digital still camera 72 is shown. The housing 72 has an image inputting portion, an image recording portion, an inputting portion for setting image taking conditions, a switch for an image-capture operation and the like built-in, in addition to the display apparatus illustrated in FIG. 1. Then, the display apparatus can display a content which has been input from the inputting portion according to the order of the user, a video image which has been taken in through the video image inputting portion, or an image which has been recorded in the image recording portion, on a display region 73.

When the video display apparatus employs the organic EL device as a light-emitting device similarly to the video image display apparatus of FIG. 13A, the apparatus displays an image with a large contrast which is a ratio of a white display to a black display, because the organic EL device itself emits light, and accordingly can display an image of high quality. The display apparatus also can lower the power consumption compared to that of a liquid crystal screen by lowering the brightness of a background of its screen, and accordingly is suitable for the application to portable apparatuses.

Until now, mainly an active-matrix type organic EL display has been described as a specific example of the display apparatus according to the present invention, but the display apparatus according to the present invention can be applied also to display apparatuses such as a passive-matrix type organic EL device and an FED.

In addition, in the above described embodiments, the display screen was divided into two blocks for double speed and was divided into three blocks for triple speed, but in the case of the display apparatus which is required to divide its display screen into more blocks, the screen may be divided into more blocks.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2009-024850, filed Feb. 5, 2009, which is hereby incorporated by reference herein in its entirety.

1. A display apparatus for displaying a video data of N frames/sec in a speed of M times in a display screen comprising a plurality of pixels arranged in a matrix comprising:
a conversion unit for converting the video data of N frames/sec into a video data in the speed of M times, wherein N and M are natural numbers; and
a display unit for block interlace scanning such that scanning lines in the display screen are classified into M blocks, and the interlace scanning is conducted one block by one block, to display on the M blocks the video data in the speed of M times in the same display timing as a speed of a single times.

2. The display apparatus according to claim 1, wherein
when the video data of a frame I is divided into M blocks of (A-1), (A-2), (A-3), , , , (A-M) in this order from top to bottom in the display screen, and the video data of a frame I+1 next to the frame I is divided into M blocks of (B-1), (B-2), (B-3), , , , (B-M) in this order from top to bottom in the display screen, a combination of blocks (B-1), (B-2), (B-3), , , , (B-X) and (A-(X+1)), (A-(X+2)), (A-(X+3)), , , , (A-M) are displayed in X th sub frame (X=1˜M) in this order from top to bottom in the display screen.

3. A display apparatus for displaying a video data of N frames/sec in a speed of M times in a display screen comprising a plurality of pixels arranged in a matrix comprising:
a conversion unit for converting the video data of N frames/sec into a video data in the speed of M times, wherein N and M are natural numbers; and
a display unit for block interlace scanning such that scanning lines in the display screen are classified into L blocks, wherein L is natural numbers larger than M, and the interlace scanning is conducted one block by one block, to display on the L blocks the video data in the speed of M times in the same display timing as a speed of a single times.

4. The display apparatus according to claim 3, wherein
when the video data of a frame I is divided into L blocks of (A-1), (A-2), (A-3), , , , (A-L) in this order from top to bottom in the display screen, and the video data of a frame I+1 next to the frame I is divided into L blocks of (B-1), (B-2), (B-3), , , , (B-L) in this order from top to bottom in the display screen,
and when Y is a natural number larger than M and varies from 1 to L,
from L display combinations of blocks (B-1), (B-2), (B-3), , , , (B-Y) and (A-(Y+1)), (A-(Y+2)), (A-(Y+3)), , , , (A-L), M combinations of the blocks are selected to be displayed as M sub frames, in an order from the sub frame of smallest Y value to the sub frame of largest Y value in the display screen.

5. A display method for displaying a video data of N frames/sec in a speed of M times in a display screen comprising a plurality of pixels arranged in a matrix comprising steps of:
converting the video data of N frames/sec into a video data in the speed of M times, wherein N and M are natural numbers; and
block interlace scanning such that scanning lines in the display screen are classified into M blocks, and the interlace scanning is conducted one block by one block, to display on the M blocks the video data in the speed of M times in the same display timing as a speed of a single times.

6. The display method according to claim 5, wherein when the video data of a frame I is divided into M blocks of (A-1), (A-2), (A-3), , , , (A-M) in this order from top to bottom in the display screen, and the video data of a frame I+1 next to the frame I is divided into M blocks of (B-1), (B-2), (B-3), , , , (B-M) in this order from top to bottom in the display screen, a combination of blocks (B-1), (B-2), (B-3), , , , (B-X) and (A-(X+1)), (A-(X+2)), (A-(X+3)), , , , (A-M) are displayed in X th sub frame (X=1˜M) in this order from top to bottom in the display screen.

7. A display method for displaying a video data of N frames/sec in a speed of M times in a display screen comprising a plurality of pixels arranged in a matrix comprising steps of:
converting the video data of N frames/sec into a video data in the speed of M times, wherein N and M are natural numbers; and
block interlace scanning such that scanning lines in the display screen are classified into L blocks, wherein L is natural numbers larger than M, and the interlace scanning is conducted one block by one block, to display on the L blocks the video data in the speed of M times in the same display timing as a speed of a single times.

8. The display method according to claim 7, wherein
when the video data of a frame I is divided into L blocks of (A-1), (A-2), (A-3), , , , (A-L) in this order from top to bottom in the display screen, and the video data of a frame I+1 next to the frame I is divided into L blocks of (B-1), (B-2), (B-3), , , , (B-L) in this order from top to bottom in the display screen,
and when Y is a natural number larger than M and varies from 1 to L,
from L display combinations of blocks (B-1), (B-2), (B-3), , , , (B-Y) and (A-(Y+1)), (A-(Y+2)), (A-(y+3)), , , , (A-1), M combinations of the blocks are selected to be displayed as M sub frames, in an order from the sub frame of smallest Y value to the sub frame of largest Y value in the display screen.
